(19) United States
(12) Patent Application Publication
(10) Pub. No.: US 2026/0310234 A1
(43) Pub. Date: Oct. 8, 2026

(54) AUTONOMOUS SECURITY ROBOT SYSTEM WITH AI-DIRECTED PHYSICAL DETERRENCE

(71) Applicants: Ching-Tien Ho, San Jose, CA (US); Theodore Lee, San Jose, CA (US); David Fong, Sunnyvale, CA (US)

(72) Inventors: Ching-Tien Ho, San Jose, CA (US); Theodore Lee, San Jose, CA (US); David Fong, Sunnyvale, CA (US)

(73) Assignee: Agape-1 Technology Inc., San Jose, CA (US)

(21) Appl. No.: 19/686,495

(22) Filed: May 22, 2026

Related U.S. Application Data
(63) Continuation of application No. 19/172,536, filed on Apr. 7, 2025.

(51) Int. Cl. G05D 1/689; A62C 31/00; B25J 11/00; B25J 15/00; B25J 17/02; B60S 3/04; G05D 105/10; G05D 105/35

(52) U.S. Cl. CPC G05D 1/6895; A62C 31/005; B25J 11/002; B25J 15/0019; B25J 17/0283; B60S 3/04; G05D 2105/10; G05D 2105/35

(57) ABSTRACT

A mobile security robot system comprising a robotic arm and a water cannon system configured to be deployed on an autonomous vehicle to perform various security, maintenance, and emergency functions. The robotic arm system is characterized by precise multi-axis movement, allowing it to aim the water cannon at a desired location and distance. The water cannon system can be preloaded with water or various mixtures for various applications. A control software module integrates with the navigation system and an AI-based threat detection system to direct the robotic arm and water cannon based on the robot's location, speed, and target destination. This invention offers a flexible and efficient solution for a variety of tasks, including crime deterrence, firefighting, street cleaning, and vehicle maintenance, while also being adaptable to stationary and mobile configurations.

### FIELD

The present invention relates to the field of autonomous security robot systems, and more particularly to methods and devices employed by the security robot, incorporating AI methodologies, sensors, and robotic arms.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Living peacefully in a community without fear of threats from criminals is a universal desire. While police forces work tirelessly to maintain peace, their limited resources can be supplemented by mobile security robots to further enhance the safety and security of individuals and communities. As a result, various types of security robots have been deployed to perform safety and security functions to assist communities. However, there is still significant room for improvement in the functionality of these security robots to better serve the community.

For this reason, a Mannequin Robot System is disclosed in U.S. patent application Ser. No. 18/661,714. The system consists of an autonomous vehicle, a mannequin mounted on the vehicle, and various related sensors and devices for autonomous navigation, security patrolling, and communications. Additionally, a Crime Detection and Deterrence System (CDDS) is disclosed in U.S. patent application Ser. No. 19/060,805. This CDDS includes an AI-based multimodal Large Language Model (LLM) designed to automatically detect potential threats. The AI engine (i.e., the multimodal LLM) can also function as a chatbot engine to communicate with individuals the robot encounters while patrolling the private property it is guarding.

The system processes surrounding audio and video inputs captured by the mobile security robot while patrolling the property. It then analyzes the captured videos, images, and audio using a pre-trained multimodal Large Language Model (LLM) deployed on the robot. When a potential threat is detected, the system engages in intelligent conversations, impersonating a security guard. The system can also communicate remotely with a security guard (a real person) or with local or federal authorities (such as local police departments at the city, county, or state level, or the FBI), depending on the severity and location of the threat.

While the aforementioned Mannequin Robot and CDDS can perform effective security patrols and crime detection to protect the community, a cost-effective mechanism to deter crimes upon detection provides a next-level improvement in community security. Therefore, the purpose of this invention is to provide a Robotic Arm and Water Cannon system for enhanced crime deterrence.

Following the detection of a potential threat using the Mannequin Robot Patent and CDDS systems, the same security robot system can perform effective crime deterrence with its pre-installed robotic arm and water cannon systems. These systems work together to direct highly pressurized water streams to any location within the surrounding area, reaching any distance achievable by the water cannon.

### SUMMARY

A mobile security robot system equipped with a robotic arm and a water cannon system is disclosed. This system can be deployed on an autonomous vehicle.

The system can perform various security, maintenance, and emergency functions using the robotic arm and water cannon system while conducting security patrols via its autonomous vehicle platform.

The robotic arm system enables precise multi-axis movement, allowing the water cannon to be aimed at a desired location and distance. The water cannon can be preloaded with water or various mixtures, such as fire-extinguishing agents, riot control chemicals, or car washing solutions, for different applications.

The system includes a control software module integrated with the navigation system and an AI-based threat detection system. The AI system directs the robotic arm and water cannon based on the robot's location, speed, and target destination.

The mobile security robot system provides a flexible and efficient solution for various tasks, including crime deterrence, firefighting, street cleaning, and vehicle maintenance. It is also adaptable to both stationary and mobile configurations.

Further areas of applicability of the present disclosure will become apparent from the detailed description provided hereinafter. The detailed description and specific examples are intended for illustration only and should not be construed to limit the scope of the disclosure.

### BRIEF DESCRIPTION OF THE DRAWINGS

The present disclosure will be better understood from the detailed description and the accompanying drawings, wherein:

FIG. 1 is a schematic diagram of a security robot system integrated with a robotic arm and water cannon system; and

FIG. 2 is a schematic diagram providing more detailed views of the robotic arm and water cannon system.

### DETAILED DESCRIPTION

The following description is merely exemplary in nature and is in no way intended to limit the disclosure, its application, or uses. It should be understood that steps within a method may be executed in different order without altering the principles of the present disclosure unless otherwise specified.

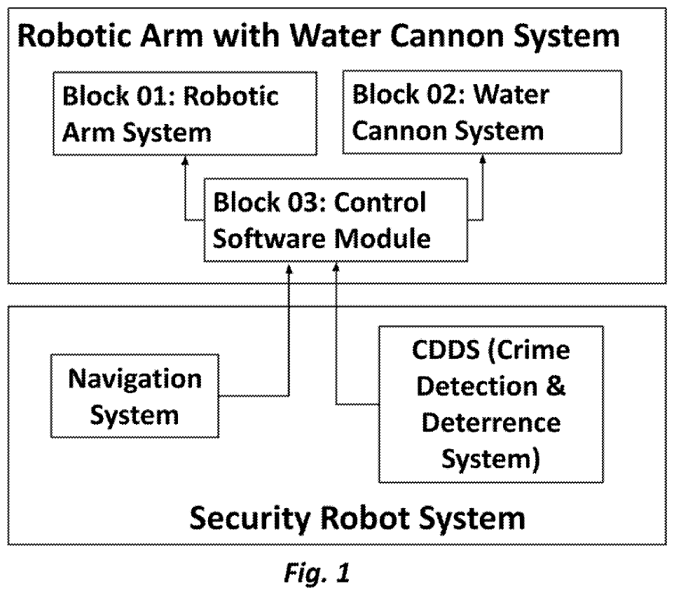

Referring now to FIG. 1, a schematic of a security robot system integrated with a robotic arm and water cannon system is shown. This drawing depicts the functional blocks of the present invention, which includes a robotic arm system (Block 01), a water cannon system (Block 02), and a control software component (Block 03). These components interact with the robotic arm system, the water cannon system, the navigation system, and the CDDS AI system.

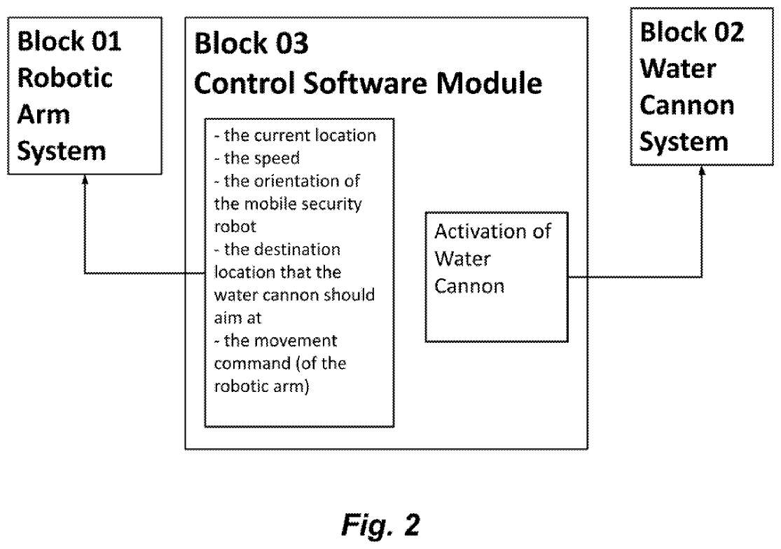

FIG. 2 provides additional details of the robotic arm system (Block 01). Upon activation, the robotic arm system receives the following inputs:
The current location, speed, and orientation of the mobile security robot from the control software (Block 03)
The destination location that the water cannon, as provided by the control software (Block 03)
The water cannon settings, as provided by the control software (Block 03)

Based on the descriptions in the above figures, the present invention involves a pre-installed robotic arm system and water cannon system integrated onto the mobile security robot chassis platform. While navigating autonomously on private property, the Crime Detection and Deterrence System (CDDS) continuously collects audio and video data, analyzes them using AI, and determines whether a potential threat exists. Once a potential threat is detected, the Robotic Arm and Water Cannon System responds accordingly.

More specifically, the security robot may navigate toward the location of the threat or suspect. Sensor devices on the mobile vehicle (or mannequin) compute the location and distance in real time. The robotic arm's movement is controlled by both hardware (mechanical, electrical, or hydraulic systems) and software, enabling it to aim the water cannon at the target location and distance. Once aimed, the water cannon system is activated, responding to the detected threat.

In one embodiment, the choice of robot arm is based on several considerations. Any robotic arm with at least three axes can achieve 360 degrees of freedom, allowing it to point in any horizontal direction and at any vertical angle, from 90 degrees above the horizon to 90 degrees below. However, certain angles may be obstructed by the robotic vehicle itself, depending on the arm's mounting location and the size and shape of the autonomous vehicle. A robotic arm with fewer than three axes may also be used as a cost-saving measure, covering most of the areas a more complex arm could reach. For areas not covered, the autonomous vehicle's movement can be used to position the robot arm at the desired location.

The manufacture of the robotic arm involves the following factors: The robotic arms can either be custom-made by a manufacturer or developed as an ODM extension of existing robotic arm models to reduce manufacturing costs. If the latter option is selected, the following modifications are necessary:
1. The base of the robotic arm must include a bolt-down platform for secure attachment to the vehicle.
2. The far end of the robotic arm must be designed to accommodate various hand attachments or utility tools, as described later.
3. The attachment of the water cannon to the far end of the robotic arm may require a specialized design.

The simplest solution is to use a grasp-type robotic arm to hold the far end of the water hose. This approach does not require customized integration, but the precision of the water stream's direction may be lower than with a more tightly integrated solution. A customized design, where the far end of the robotic arm is directly integrated with the water hose, would provide a more stable and precise water stream direction.

Regarding robotic arm installation, most commercially available robotic arms have a heavy base and often include a bolt-down platform for secure attachment to a flat surface. The preferred location for mounting the robotic arm on the vehicle is near its center of gravity, which is typically close to the geometric center. However, for operational convenience, it may be beneficial to install the robotic arm near the vehicle's edge or corner. This creates an optimization problem that requires balancing both stability and accessibility.

One solution is to design the vehicle such that heavier components are deliberately positioned away from the robotic arm's mounting point to help balance the weight distribution.

Another solution is to position the water tank away from the mounting point. However, this may create a balance issue when the tank is empty. To mitigate this, software control should limit the arm's extension based on the remaining water capacity.

Various aspects of robotic arm hand attachments and related utilities may be considered for certain embodiments. A key advantage of this invention is that the robotic arm can be equipped with various grippers, devices, or tools for different purposes. It is also possible to install multiple robotic arms, allowing different attachments to be used simultaneously without changing configurations during a mission. Below are some illustrative examples of hand attachments for various utilities:

Security and Surveillance: The robotic arm can be equipped with a badge reader, barcode reader, or a camera for license plate or facial recognition. This configuration is ideal for guarding entrances to private properties, such as parking lots or buildings.

Tire Maintenance: The robotic arm can carry tools and supplies for fixing or replacing flat tires, such as a nail remover, socket wrench, jack, compressed air, or a collection of spare tires in various sizes.

Vehicle Maintenance: The robotic arm can carry soap, detergent, water, cloths, and waxes for washing cars, such as employee vehicles in designated parking areas.

Locksmithing: The robotic arm can be equipped with locksmith tools to open locked cars or rooms.

Gardening: The robotic arm can carry an electric saw or cutter for tasks like shaping trees or bushes and removing branches.

Law Enforcement: The robotic arm can be equipped with an armor shield to protect officers in dangerous encounters with armed criminals or explosives.

Explosive Handling: The robotic arm can be equipped with a heavy metal box designed to safely contain explosive materials.

Energy Generation: The robotic arm can extend or attach to a solar panel, which is connected to a battery compartment for recharging the vehicle's battery pack. The panel can be oriented toward the sun to optimize energy collection.

The solar panel can be activated when the vehicle is idle or in patrol mode, ensuring it does not interfere with navigation. During an active mission, the panel may be detached from the robotic arm, allowing it to attach to other hand tools or utilities.

The water cannon infrastructure includes the basic components required to install and deploy the system, either from within the vehicle or a stationary station if mobility is not essential:
Water Tank Container: The water supply is preloaded into one or more containers embedded in the vehicle, referred to as water tanks. Each tank is an independent unit with an entry hole for filling and an outlet for dispensing water.
Water Hose: One end of the water hose connects to the outlet of each water tank.
Motor/Compressor: A motor or compressor generates the high-pressure water stream. This motor can be either electrical or hydraulic.
Attachment to the Robotic Arm: The other end of the water hose is attached (e.g., embedded in or integrated into) the far end of the robotic arm. This allows the robotic arm to guide the water stream's location and distance accurately. The distance is controlled by adjusting the arm's height and angle, as well as regulating the pressure generated by the motor of the water cannon system.

In addition to crime deterrence, the water cannon system can be utilized for various purposes. For illustration, and not by way of limitation, the water cannon system may serve the following functions:
Crime Deterrence: Discourage riots and other disruptive activities.
Street Sweeping: Assist in cleaning streets, highways, homeless areas, and major event cleanups.
Tree Leaf Blowing: Use compressed or pressurized air to blow, stack, and collect tree leaves.
Snow Blowing: Use compressed or pressurized air to clear or stack snow.
Watering Service: Provide watering services for golf courses, large farms, public or private gardens, HOA communities, corporate campuses, and university campuses.

A variety of water mixtures can be used in the water cannon system for crime deterrence and other utilities. In addition to pure water stored in the water tank(s), the vehicle may have additional containers to store different mixtures that can be added before the water cannon dispenses the streams. Depending on the intended purpose, the following mixtures may be considered:
Firefighting: Pure water or fire extinguishing chemicals, either on their own or mixed with water, can be used to enhance firefighting effectiveness.
Crowd Control: Chemicals can be mixed into the water to deter crowds during riot situations. A colored ink, such as red ink, can also be added for effective crowd management.
Military Use: In combat situations, certain chemicals can be mixed into the water, following the guidelines set by the Geneva Conventions.
Car Washing: For commercial applications, soap, detergent, or wax-like chemicals can be mixed with water for car washing missions.

The robotic arm system can also perform more sophisticated car services, although additional authorization may be required for the security robot system to be registered with a private or government organization and gain access to car keys. These services include, but are not limited to:
Car Towing Service
Car Battery Jumping Service
Car Battery Health Check
Car Battery Recharge Service
Car Gasoline Emergency Supply.

From the above description, it is clear that this robotic arm and water cannon system is most useful when integrated with the mobility of an autonomous vehicle platform. However, certain applications may not require mobility. For example, a robotic arm stationed at a fixed location, such as a parking lot gate or the main entrance of a building, can still perform various utility services as described earlier. Thus, the invention can be used in both mobile and stationary configurations.

The broad teachings of this disclosure can be implemented in various forms. While particular examples are provided, the true scope of the disclosure should not be limited to these examples, as other modifications will become apparent to those skilled in the art upon reviewing the drawings, the specification, and the following claims.

What is claimed is:

1. An autonomous security robot system, comprising:
an autonomous mobile platform configured to navigate within a physical environment;
a sensor system configured to capture environmental information associated with one or more persons, objects, or events within the physical environment;
an artificial intelligence-based threat analysis system configured to analyze the environmental information and determine a potential threat condition;
a robotic actuator system coupled to the autonomous mobile platform, the robotic actuator system being configured to physically position at least one deterrence device toward a target location associated with the potential threat condition; and
a control system configured to:
receive threat information from the artificial intelligence-based threat analysis system,
determine a deployment of the deterrence device associated with the potential threat condition, and
control movement of the robotic actuator system to direct the deterrence device toward the target location.

2. The autonomous security robot system of claim 1, wherein the robotic actuator system comprises a multi-axis robotic arm configured to rotate horizontally and vertically to direct the deterrence device toward the target location.

3. The autonomous security robot system of claim 1, wherein the deterrence device comprises a water cannon configured to discharge a pressurized liquid stream toward the target location, the pressurized liquid stream comprising water, a fire-extinguishing agent, a crowd-control chemical, a colored marking agent, or a cleaning solution.

4. The autonomous security robot system of claim 1, wherein the autonomous mobile platform is configured to navigate toward the target location prior to deployment of the deterrence device.

5. The autonomous security robot system of claim 1, wherein the control system is configured to limit movement or extension of the robotic actuator system based on a remaining quantity of fluid stored within the autonomous mobile platform.

6. The autonomous security robot system of claim 1, wherein the control system is configured to determine the target location based on sensor data captured by the sensor system, the sensor data comprising image data, audio data, depth data, or combinations thereof.

7. The autonomous security robot system of claim 1, wherein the robotic actuator system is configured to adjust positioning of the deterrence device based on updated sensor data associated with the target location.

8. The autonomous security robot system of claim 1, wherein the robotic actuator system is configured to support interchangeable tool attachments associated with different operational tasks.

9. The autonomous security robot system of claim 8, wherein the interchangeable tool attachments comprise at least one of: a badge reader, a camera, a cleaning device, a cutting device, a firefighting device, a maintenance tool, or an explosive-handling device.

10. The autonomous security robot system of claim 9, wherein the interchangeable tool attachments comprise a solar panel, and wherein the control system is configured to orient the solar panel toward a light source while the autonomous mobile platform is in an idle or patrol mode.

11. A method for autonomously performing physical deterrence operations using a
mobile security robot system, comprising:
capturing environmental data associated with a surrounding environment using one or more sensors deployed on a mobile security robot;
analyzing the environmental data using an artificial intelligence-based analysis system to identify a potential threat condition;
determining, based on the identified potential threat condition, a target location associated with a physical deterrence response;
positioning a robotic actuator system toward the target location; and
activating a deterrence device coupled to the robotic actuator system to perform a physical deterrence operation toward the target location.

12. The method of claim 11, further comprising autonomously navigating the mobile security robot toward the target location before activating the deterrence device.

13. The method of claim 11, wherein positioning the robotic actuator system comprises adjusting an angle or elevation associated with the deterrence device based on a distance associated with the target location.

14. The method of claim 11, wherein activating the deterrence device comprises controlling a pressure level associated with a discharged fluid stream.

15. The method of claim 11, wherein the identified potential threat condition is determined using a multimodal artificial intelligence analysis system configured to analyze both audio and video information.

16. An autonomous robotic response system, comprising:
an artificial intelligence-based analysis engine configured to detect a potential threat condition based on environmental data captured within a physical environment;
a robotic actuator platform mounted on a mobile robotic system;
a physical deterrence mechanism coupled to the robotic actuator platform; and
a control module configured to:
determine a target location associated with the potential threat condition;
position the robotic actuator platform toward the target location; and
deploy the physical deterrence mechanism toward the target location in response to the detected potential threat condition.

17. The autonomous robotic response system of claim 16, wherein the physical deterrence mechanism comprises a fluid-dispensing device configured to deploy a pressurized stream toward the target location.

18. The autonomous robotic response system of claim 16, wherein the robotic actuator platform is mounted on an autonomous mobile robotic vehicle configured to patrol a private property.

19. The autonomous robotic response system of claim 16, wherein the robotic actuator platform is configured to support multiple operational tools associated with security, maintenance, cleaning, or emergency-response operations.

20. The autonomous robotic response system of claim 16, wherein the physical deterrence mechanism is deployable from either a mobile robotic platform or a stationary robotic installation.
